(19) United States
(12) Patent Application Publication
(10) Pub. No.: US 2023/0038482 A1
(43) Pub. Date: Feb. 9, 2023

(54) POLYCARBONATE COMPOSITIONS CONTAINING FILLERS AND TRIACYLGLYCEROL CONTAINING EPOXY GROUPS

(71) Applicant: COVESTRO INTELLECTUAL PROPERTY GMBH & CO. KG, Leverkusen (DE)

(72) Inventors: Helmut Werner HEUER, Siegen (DE); Rolf WEHRMANN, Krefeld (DE); Anke BOUMANS, Bedburg-Hau (DE)

(21) Appl. No.: 17/785,471

(22) PCT Filed: Nov. 20, 2020
(86) PCT No.: PCT/EP2020/082915

§ 371 Date: Jun. 15, 2022

(30) Foreign Application Priority Data
Dec. 17, 2019 (EP) 19216962.1

(51) Int. Cl. C08K 5/42; C08K 5/1515; C08K 7/14; C08K 7/06; C08K 3/04

(52) U.S. Cl. CPC C08K 5/42; C08K 5/1515; C08K 7/14; C08K 7/06; C08K 3/04

(57) ABSTRACT

The invention relates to carbon fiber-containing polycarbonate compositions, the flowability of which is significantly improved by adding epoxidized triacylglycerols, for example as a constituent of epoxidized soy bean oil. In addition to the very high flowability, the compositions according to the invention have a high rigidity.

The present invention relates to carbon fiber-reinforced polycarbonate-containing compositions having high flowability, exceptional stiffness and good flame retardancy properties. Furthermore, the present invention relates to moldings, for instance for housings or housing parts in the electricals and electronics sector and IT sector, for example for electrical housings/switch boxes or for frames of LCD/LED screens, and also for housings/housing parts of mobile communications terminals such as smartphones, tablets, ultrabooks, notebooks or laptops, but also for navigation devices, smartwatches or heart rate monitors, and also electrical applications in thin-wall designs, for example home and industrial networking units and smart meter housing components.

The addition to plastics, such as polycarbonate, of glass fibers or carbon fibers which improve stiffness is known from the prior art. A large number of flame retardants which are suitable for polycarbonate are also known. However, optimization of the properties of a polycarbonate in terms of stiffness and flame retardancy properties is simultaneously associated with a deterioration in flowability which is problematic particularly with respect to thin-wall applications.

WO 2013/045552 A1 describes glass-fiber-filled flame-retardant polycarbonates having a high degree of stiffness coupled with good toughness. It teaches nothing about the possibility of improving the flowability of corresponding compositions. In addition, U.S. Pat. No. 3,951,903 A describes the use of carboxylic anhydrides in glass-fiber-filled polycarbonates for improving stress cracking resistance. EP 0 063 769 A2 describes a polycarbonate comprising glass fibers and polyanhydride and exhibiting improved impact strength. An improvement in flowability is not described.

The conventional way to improve flow is to use BDP (bisphenol A diphosphate), specifically in amounts of up to more than 10% by weight, in order to achieve the desired effect. However, such high amounts of BDP involve the acceptance of impairments in other properties.

It was an object of the present invention to provide reinforced polycarbonate-containing compositions having a combination of good flowability and also high stiffness and ideally a flame resistance of UL94 V-0 for moldings produced with a 1.5 mm wall thickness, and also corresponding moldings having sufficient flow characteristics during processing.

Surprisingly, it has been found that glass fiber- and/or carbon fiber-containing compositions based on polycarbonate exhibit improved flowability, and the mechanical properties, determined by means of a tensile test, remain virtually unchanged when epoxidized triacylglycerol, in particular in the form of epoxidized soybean oil, is present.

Although epoxidized soybean oil has already previously been described as an additive for polycarbonate, it has not been done so with respect to an improvement in the flowability of glass fiber- or carbon fiber-containing compositions. For example, CN105400167 A describes the addition of small amounts of epoxidized soybean oil as part of a complex plasticizer mixture. However, plasticizers are known to result in a considerable deterioration in the mechanical properties of a polycarbonate composition. The use as plasticizer is also different from the use for improving the flowability, which relates to the melt of a thermoplastic composition.

The polycarbonate compositions containing epoxidized triacylglycerol, in particular in the form of epoxidized soybean oil, preferably display good melt stabilities with improved rheological properties, namely a higher melt volume-flow rate (MVR), determined in accordance with DIN EN ISO 1133:2012-03 (at a test temperature of 300° C., mass 1.2 kg), lower shear viscosities at various temperatures and over a broad shear range, and also a good, i.e. lower, melt viscosity, determined in accordance with ISO 11443:2005.

Compositions according to the invention are therefore thermoplastic compositions containing
A) 50.0% by weight to 91.95% by weight of aromatic polycarbonate,
B) 8% to 49.95% by weight of carbon fibers,
C) 0.05% by weight to 10.0% by weight of epoxidized triacylglycerol, in particular introduced into the composition in the form of epoxidized soybean oil.

The compositions preferably contain
A) 74.0% to 91.9% by weight of aromatic polycarbonate,
B) 8% to 25.0% by weight of carbon fibers,
C) 0.1% to 1.0% by weight of epoxidized triacylglycerol, in particular introduced into the composition in the form of epoxidized soybean oil,
D) 0.0% by weight to 1.0% by weight of heat stabilizer and
E) 0.0% by weight to 10.0% by weight of further additives.

The compositions particularly preferably contain
A) 77.0% by weight to 91.5% by weight of aromatic polycarbonate,
B) 8% to 22% by weight of carbon fibers,
C) 0.2% to 1.0% by weight, in particular up to 0.8% by weight, of epoxidized triacylglycerol, in particular introduced into the composition in the form of epoxidized soybean oil,
D) 0.005% to 0.5% by weight, in particular 0.01% to 0.2% by weight, of heat stabilizer and
E) 0.0% by weight to 3% by weight, in particular 0.1% to 3% by weight, of further additives.

As further additive, at least one alkali metal, alkaline earth metal and/or ammonium salt of an aliphatic or aromatic sulfonic acid, sulfonamide or sulfonimide derivative is particularly preferably present, preferably in an amount of from 0.1% to 0.5% by weight, based on the overall composition; in particular at least potassium perfluoro-1-butanesulfonate is present.

Extremely preferably, the above-described compositions do not contain any further components, and instead the amounts of components A), B), C)— optionally C1)— epoxidized soybean oil, containing epoxidized triacylglycerol—and optionally D) and/or E), in particular in the above-described preferred embodiments, add up to 100% by weight.

In the context of the present invention—unless explicitly stated otherwise—the stated percentages by weight for components A, B, C— or C1— and optionally D and/or E, are each based on the total weight of the composition. It will be appreciated that all components present in a composition according to the invention together give 100% by weight. In addition to the components A, B, C and D, the composition may comprise further components, for instance further additives in the form of component E. The composition may also contain one or more further thermoplastics as blend partners. The above-described compositions very particularly preferably do not contain any further components, and instead the amounts of components A), B), C) (or C1) and optionally D) and/or E), in particular in the above-described preferred embodiments, add up to 100% by weight, i.e. the compositions consist of components A), B), C) (optionally C1)), optionally D) and/or E).

It will be appreciated that the employed components may contain typical impurities arising for example from their production process. It is preferable to use the purest possible components. It will further be appreciated that these impurities may also be present in the event of an exhaustive formulation of the composition.

The compositions according to the invention are preferably used for producing moldings. The compositions preferably have a melt volume-flow rate (MVR) of 2 to 30 cm³/(10 min), more preferably of 3 to 25 cm³/(10 min), particularly preferably of 4 to 15 cm³/(10 min), very particularly preferably of 5 to 13 cm³/(10 min), determined in accordance with ISO 1133:2012-3 (test temperature 300° C., mass 1.2 kg).

The invention also provides the improvement in the flowability, manifested in an increase in the melt volume-flow rate, determined in accordance with DIN EN ISO 1133:2012-03 at a test temperature of 300° C. and with a mass of 1.2 kg, and/or a reduction in the melt viscosity, determined in accordance with ISO 11443:2005, of glass fiber- and/or carbon fiber-containing polycarbonate compositions, by means of the addition of epoxidized triacylglycerol, in particular in the form of epoxidized soybean oil. The improvement in the flowability is based on the corresponding compositions without epoxidized triacylglycerol, in particular in the form of an epoxidized soybean oil.

The individual constituents of the compositions according to the invention are more particularly elucidated hereinbelow:

### Component A

For the purposes of the invention, the term “polycarbonate” is understood to mean both aromatic homopolycarbonates and aromatic copolycarbonates. The polycarbonates may be linear or branched in the known manner. Mixtures of polycarbonates may also be used according to the invention.

Compositions according to the invention contain, as component A), 50.0% by weight to 99.45% by weight of aromatic polycarbonate. In accordance with the invention, a proportion of at least 50.0% by weight of aromatic polycarbonate in the overall composition means that the composition is based on aromatic polycarbonate. The amount of the aromatic polycarbonate in the composition is preferably 74.0% to 94.0% by weight, more preferably 77.0% to 91.5% by weight, more preferably still 78.0% to 90.0% by weight, it being possible for a single polycarbonate or a mixture of two or more polycarbonates to be present.

If a mixture of polycarbonates is used, this preferably contains 65% to 85% by weight, more preferably 70% to 80% by weight, of aromatic polycarbonate having an MVR of 5.0 to 20 cm³/(10 min), more preferably 5.5 to 11 cm³/(10 min), more preferably still 6.0 to 10 cm³/(10 min), determined in accordance with ISO 1133:2012-03 and determined at a test temperature of 300° C. and with 1.2 kg load, and also 5% to 15% by weight, preferably 7% to 13% by weight, more preferably 8% to 12% by weight, of aromatic polycarbonate having an MVR of 4 to <8.0 cm³/(10 min), preferably of 5 to 7 cm³/(10 min), determined in accordance with ISO 1133:2012-03 at a test temperature of 300° C. and with 1.2 kg load. Of the aromatic polycarbonate having an MVR of 4 to <8.0 cm³/(10 min), preferably of 5 to 7 cm³/(10 min), determined in accordance with ISO 1133:2012-03 at a test temperature of 300° C. and with 1.2 kg load, it is particularly preferable for 50% to 75% by weight, more preferably 55% to 70% by weight, based on the total amount of aromatic polycarbonate having an MVR of 4 to <8.0 cm³/(10 min), preferably of 5 to 7 cm³/(10 min), to be used in powder form.

The polycarbonates present in the compositions are produced in a known manner from dihydroxyaryl compounds, carbonic acid derivatives, and optionally chain terminators and branching agents.

Details of the production of polycarbonates have been set out in many patent specifications over the past 40 years or so. Reference may be made here for example to Schnell, “Chemistry and Physics of Polycarbonates”, Polymer Reviews, Volume 9, Interscience Publishers, New York, London, Sydney 1964, and to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and lastly to U. Grigo, K. Kirchner and P. R. Midler “Polycarbonate” [Polycarbonates] in Becker/Braun, Kunststoff-Handbuch [Plastics Handbook], Volume 3/1, Polycarbonate, Polyacetale, Polyester, Celluloseester [Polycarbonates, polyacetals, polyesters, cellulose esters], Carl Hanser Verlag Munich, Vienna 1992, pages 117 to 299.

Aromatic polycarbonates are produced, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is production via a melt polymerization method, by reacting dihydroxyaryl compounds with diphenyl carbonate, for example.

Dihydroxyaryl compounds suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein and the ring-alkylated, ringarylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

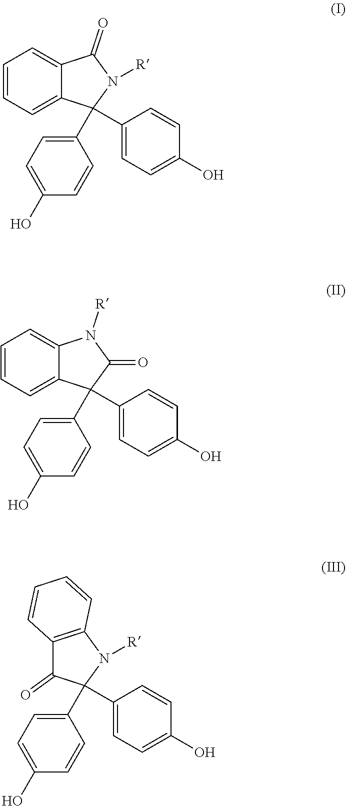

in which each R′ is C₁- to C₄-alkyl, aralkyl or aryl, preferably methyl or phenyl, very particularly preferably methyl.

Particularly preferred bisphenols are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in U.S. Pat. Nos. 3,028,635, 2,999,825, 3,148,172, 2,991,273, 3,271,367, 4,982,014 and 2,999,846, in DE-A 1 570 703, DE-A 2063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986 and JP-A 105550/1986.

In the case of homopolycarbonates only one dihydroxyaryl compound is used; in the case of copolycarbonates two or more dihydroxyaryl compounds are used.

Examples of suitable carbonic acid derivatives are phosgene or diphenyl carbonate.

Suitable chain terminators that may be employed in the production of the polycarbonates are monophenols. Examples of suitable monophenols include phenol itself, alkylphenols such as cresols, p-tert-butylphenol, cumylphenol, and also mixtures thereof.

Preferred chain terminators are the phenols which have substitution by one or more linear or branched, preferably unsubstituted, C₁ to C₃O-alkyl radicals, or by tert-butyl. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents are 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane, 1,4-bis((4′,4″-dihydroxytriphenyl)methyl)benzene, and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the copolycarbonates based on 1,1-bis(4-hydroxyphenyl)-3,3,5-trimethylcyclohexane and 4,4′-dihydroxydiphenyl and also the copolycarbonates based on the two monomers bisphenol A and 1,1-bis(4-hydroxyphenyl)-3,3,5-trimethylcyclohexane, and also homo- or copolycarbonates derived from the dihydroxyaryl compounds of formulae (I), (II) and/or (III)

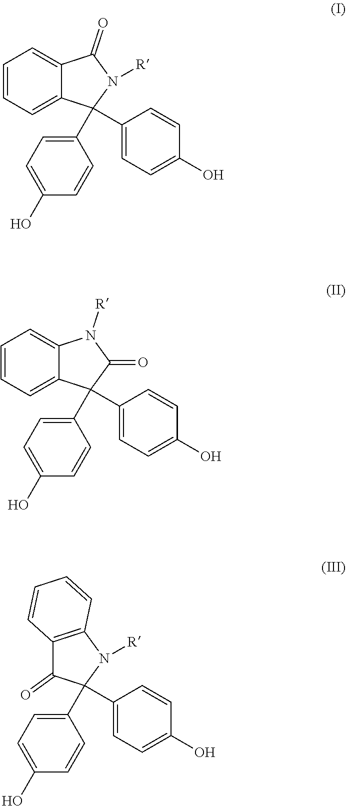

in which each R′ is C₁- to C₄-alkyl, aralkyl or aryl, preferably methyl or phenyl, very particularly preferably methyl.

To achieve incorporation of additives, component A is preferably employed in the form of powders, pellets or mixtures of powders and pellets.

### Component B

Compositions according to the invention contain 0.50% to 49.95% by weight, preferably 1.0% to 35.0% by weight, more preferably 5% to 25% by weight, more preferably still 8% to 22% by weight, particularly preferably 10% to 20% by weight, of carbon fibers. With regard to the use according to the invention, these amount ranges apply for carbon fibers and/or glass fibers in a composition.

Carbon fibers are typically industrially manufactured from precursors such as polyacrylic fibers, for example, by pyrolysis (carbonization).

Long fibers and short fibers can be used in the compositions according to the invention. Preference is given to using short fibers.

The length of the chopped fibers is preferably between 3 mm and 125 mm. Particular preference is given to using fibers of 3 mm to 25 mm in length.

In addition to fibers of round cross section, fibers of cubic dimension (platelet shaped) are also usable.

In addition to chopped fibers, as an alternative preference is given to using ground carbon fibers. Preferred ground carbon fibers have lengths of 50 μm to 150 μm.

The carbon fibers optionally have coatings of organic sizing agents in order to enable particular modes of binding to the polymer matrix. The preferred sizing agents correspond to those mentioned for glass fibers.

Short chopped fibers and ground carbon fibers are typically added to the polymeric base materials by compounding.

For long threads, specific technical processes are typically used to arrange carbon in ultrafine threads. These filaments typically have a diameter of 3 to 10 μm. The filaments can also be used to produce rovings, wovens, nonwovens, tapes, hoses or the like.

10% to 30% by weight, more preferably 11% to 25% by weight, more preferably still 12% to 22% by weight, in particular up to 20% by weight, of carbon fibers are preferably present.

In connection with the use according to the invention, glass fibers should also be taken into account.

The glass fibers are typically based on a glass composition selected from the group of the M, E, A, S, R, AR, ECR, D, Q and C glasses, preference being given to E, S or C glass.

The glass fibers may be used in the form of chopped glass fibers, long and also short fibers, ground fibers, glass fiber weaves or mixtures of the abovementioned forms, preference being given to the use of chopped glass fibers and ground fibers.

Particular preference is given to using chopped glass fibers.

The preferred fiber length of the chopped glass fibers before compounding is 0.5 to 10 mm, more preferably 1.0 to 8 mm, very particularly preferably 1.5 to 6 mm.

Chopped glass fibers may be used with different cross sections. Preference is given to using round, elliptical, oval, figure-of-8 and flat cross sections, particular preference being given to round, oval and flat cross sections.

The diameter of the employed round fibers prior to compounding is preferably 5 to 25 μm, more preferably 6 to 20 μm, particularly preferably 7 to 17 μm, determined by means of analysis by light microscopy.

Preferred flat and oval glass fibers have a cross-sectional ratio of height to width of about 1.0:1.2 to 1.0:8.0, preferably 1.0:1.5 to 1.0:6.0, particularly preferably 1.0:2.0 to 1.0:4.0.

Preferred flat and oval glass fibers have an average fiber height of 4 μm to 17 μm, more preferably of 6 μm to 12 μm and particularly preferably 6 μm to 8 μm, and an average fiber width of 12 μm to 30 μm, more preferably 14 μm to 28 μm and particularly preferably 16 μm to 26 μm. The fiber dimensions are preferably determined by means of analysis by light microscopy.

The glass fibers are preferably modified with a glass sizing agent on the surface of the glass fiber.

Preferred glass sizing agents include epoxy-modified, polyurethane-modified and unmodified silane compounds and mixtures of the aforementioned silane compounds.

The glass fibers may also not have been modified with a glass sizing agent.

It is a feature of the glass fibers used that the selection of the fiber is not limited by the interaction characteristics of the fiber with the polycarbonate matrix. An improvement in the properties according to the invention of the compositions is obtained both for strong binding to the polymer matrix and in the case of a non-binding fiber.

Binding of the glass fibers to the polymer matrix is apparent in the low-temperature fracture surfaces in scanning electron micrographs, with the majority of the broken glass fibers being broken at the same height as the matrix and only individual glass fibers protruding from the matrix. In the converse case of non-binding characteristics, scanning electron micrographs show that the glass fibers protrude significantly from the matrix or have slid out completely in low-temperature fracture.

Where glass fibers are present in the composition, particular preference is given to 10% to 20% by weight of glass fibers being present in the composition.

### Component C

The compositions according to the invention contain, as component C, epoxidized triacylglycerol. Component C can be a specific triacylglycerol or a mixture of different epoxy group-containing (“epoxidized”) triacylglycerols. It is preferably a mixture of different triacylglycerols. Component C preferably contains a mixture of triesters of glycerol with oleic acid, linoleic acid, linolenic acid, palmitic acid and/or stearic acid. More preferably, the esters of component C comprise only esters of glycerol with the fatty acids mentioned. Component C is particularly preferably introduced into the compositions according to the invention in the form of epoxidized soybean oil (C₁). The CAS number of epoxidized soybean oil is 8013-07-8.

The epoxy groups in component C may be introduced by methods familiar to those skilled in the art. These methods in particular are epoxidation with peroxides or peracids, that is to say esters of glycerol with carboxylic acids containing double bonds are reacted with peroxides or peracids. In the process, some or all of the C═C double bonds in the triacylglycerols react to form epoxide groups. The triacylglycerols are therefore partially or completely epoxidized. Preferably, at least 90%, more preferably at least 95%, more preferably still at least 98%, of the C═C double bonds originating from the unsaturated carboxylic acids in the triacylglycerols are epoxidized. Component C is preferably a mixture of different compounds, as is the case, for example, with the use of epoxidized soybean oil. The OH numbers of these mixtures are preferably between 180 and 300 mg KOH/g (method 2011-0232602-92D of Currenta GmbH & Co. OHG. Leverkusen, corresponding to DIN EN LSO 2554:1998-10 with pyridine as solvent). The acid numbers of these mixtures are preferably below 1 mg KOH/g; they are more preferably ≤0.5 mg KOH/g, determined by means of DIN EN ISO 2114:2006-11. The iodine number of the mixtures according to Wijs is preferably ≤5.0 g of iodine/100 g, more preferably ≤3.0 g of iodine/100 g (method 2201-0152902-95D of Currenta GmbH & Co. OHG, Leverkusen). The oxirane number is preferably 5 to 10 g of O₂/100 g, particularly preferably 6.3 to 8.0 g of O₂/100 g.

The polycarbonate-containing compositions contain 0.05% to 10.0% by weight, preferably 0.1% to 8.0% by weight, more preferably 0.2% to 6.0% by weight, more preferably still 0.2% to 1.0% by weight, particularly preferably up to 0.8% by weight, of component C.

### Component D

The compositions according to the invention may additionally contain heat stabilizers D). Suitable heat stabilizers are in particular phosphorus-based stabilizers selected from the group of the phosphates, phosphites, phosphonites, phosphines and mixtures thereof. It is also possible to use mixtures of different compounds from one of these subgroups, for example two phosphites.

Heat stabilizers preferably used are phosphorus compounds having the oxidation number +III, in particular phosphines and/or phosphites.

Particularly preferably suitable heat stabilizers are triphenylphosphine, tris(2,4-di-tert-butylphenyl) phosphite (Irgafos® 168), tetrakis(2,4-di-tert-butylphenyl)-[1,1-biphenyl]-4,4′-diylbisphosphonite, octadecyl 3-(3,5-di-tert-butyl-4-hydroxyphenyl)propionate (Irganox® 1076), bis(2,4-dicumylphenyl)pentaerythritol diphosphite (Doverphos® S-9228), bis(2,6-di-tert-butyl-4-methylphenyl)pentaerythritol diphosphite (ADK STAB PEP-36).

They are used alone or in a mixture (for example Irganox® B900 (mixture of Irgafos® 168 and Irganox® 1076 in a 4:1 ratio) or Doverphos® S-9228 with Irganox® B900/Irganox® 1076).

The heat stabilizers are preferably used in amounts of up to 1.0% by weight, more preferably 0.003% to 1.0% by weight, more preferably still 0.005% to 0.5% by weight, particularly preferably 0.01% to 0.2% by weight.

### Component E

In addition, optionally up to 10.0% by weight, preferably 0.1% to 6.0% by weight, particularly preferably 0.1% to 3.0% by weight, very particularly preferably 0.2% to 1.0% by weight, in particular up to 0.5% by weight, of other customary additives (“further additives”) are present. The group of further additives does not include any heat stabilizers since these are already described as component D. It will be appreciated that component E also does not include any carbon fibers or any epoxy group-containing triacylglycerol, or any epoxidized soybean oil either, since these have already been described as component B and C/Cl.

Such additives as are typically added in polycarbonates are in particular antioxidants, demolding agents, flame retardants, UV absorbers, IR absorbers, impact modifiers, antistats, optical brighteners, fillers other than component B, light-scattering agents, colorants such as organic pigments, inorganic pigments such as e.g. talc, silicates or quartz and/or additives for laser marking, as are described for example in EP-A 0 839 623, WO-A 96/15102, EP-A 0 500 496 or “Plastics Additives Handbook”, Hans Zweifel, 5th Edition 2000, Hanser Verlag, Munich, in the amounts customary for polycarbonate. These additives may be added individually or else in a mixture.

Preferred additives are flame retardants, in particular alkali metal, alkaline earth metal and/or ammonium salts of aliphatic or aromatic sulfonic acid, sulfonamide and sulfonimide derivatives. As flame retardant, compositions according to the invention particularly preferably comprise one or more compounds selected from the group consisting of sodium or potassium perfluorobutanesulfonate, sodium or potassium perfluoromethanesulfonate, sodium or potassium perfluorooctanesulfonate, sodium or potassium 2,5-dichlorobenzenesulfonate, sodium or potassium 2,4,5-trichlorobenzenesulfonate, sodium or potassium diphenylsulfone sulfonate, sodium or potassium 2-formylbenzenesulfonate, sodium or potassium (N-benzenesulfonyl)benzenesulfonamide, or mixtures thereof.

Preference is given to using sodium or potassium perfluorobutanesulfonate, sodium or potassium perfluorooctanesulfonate, sodium or potassium diphenylsulfone sulfonate, or mixtures thereof. Very particular preference is given to potassium perfluoro-1-butanesulfonate, which is commercially available, inter alia, as Bayowet® C4 from Lanxess, Leverkusen, Germany.

The amounts of alkali metal, alkaline earth metal and/or ammonium salts of aliphatic or aromatic sulfonic acid, sulfonamide and sulfonimide derivatives in the composition, where these are used, preferably amount to a total of 0.1% to 0.5% by weight, more preferably 0.12% to 0.3% by weight, particularly preferably 0.15% to 0.2% by weight.

Further preferred additives are specific UV stabilizers having minimum transmittance below 400 nm and maximum transmittance above 400 nm. Ultraviolet absorbers particularly suitable for use in the composition according to the invention are benzotriazoles, triazines, benzophenones and/or arylated cyanoacrylates.

Particularly suitable ultraviolet absorbers are hydroxybenzotriazoles, such as 2-(3′,5′-bis(1,1-dimethylbenzyl)-2′-hydroxyphenyl)benzotriazole (Tinuvin® 234, BASF SE, Ludwigshafen), 2-(2′-hydroxy-5′-(tert-octyl)phenyl)benzotriazole (Tinuvin® 329, BASF SE, Ludwigshafen), bis(3-(2H-benzotriazolyl)-2-hydroxy-5-tert-octyl)methane (Tinuvin® 360, BASF SE, Ludwigshafen), 2-(4,6-diphenyl-1,3,5-triazin-2-yl)-5-(hexyloxy)phenol (Tinuvin® 1577, BASF SE, Ludwigshafen), 2-(5-chloro-2H-benzotriazol-2-yl)-6-(1,1-dimethylethyl)-4-methylphenol (Tinuvin® 326, BASF SE, Ludwigshafen), and also benzophenones such as 2,4-dihydroxybenzophenone (Chimassorb® 22, BASF SE, Ludwigshafen) and 2-hydroxy-4-(octyloxy)benzophenone (Chimassorb® 81, BASF SE, Ludwigshafen), 2,2-bis[[(2-cyano-1-oxo-3,3-diphenyl-2-propenyl)ox)]methyl]-1,3-propanediyl ester (9CI) (Uvinul® 3030, BASF SE Ludwigshafen), 2-[2-hydroxy-4-(2-ethylhexyl)oxy]phenyl-4,6-di(4-phenyl)phenyl-1,3,5-triazine (Tinuvin® 1600, BASF SE, Ludwigshafen), tetraethyl 2,2′-(1,4-phenylenedimethylidene)bismalonate (Hostavin® B-Cap, Clariant AG) or N-(2-ethoxyphenyl)-N′-(2-ethylphenyl)ethanediamide (Tinuvin® 312, CAS no. 23949-66-8, BASF SE, Ludwigshafen).

Specific particularly preferred UV stabilizers are Tinuvin® 360, Tinuvin® 329, Tinuvin 326, Tinuvin 1600 and/or Tinuvin® 312; very particular preference is given to Tinuvin® 329 and Tinuvin® 360.

It is also possible to use mixtures of the ultraviolet absorbers mentioned.

If UV absorbers are present, the composition preferably contains ultraviolet absorbers in an amount of up to 0.8% by weight, preferably 0.05% by weight to 0.5% by weight, more preferably 0.08% by weight to 0.4% by weight, very particularly preferably 0.1% by weight to 0.35% by weight, based on the overall composition.

The compositions according to the invention may also contain phosphates or sulfonic esters as transesterification stabilizers. It is preferable when triisooctyl phosphate is present as a transesterification stabilizer. Triisooctyl phosphate is preferably used in amounts of 0.003% by weight to 0.05% by weight, more preferably 0.005% by weight to 0.04% by weight and particularly preferably of 0.01% by weight to 0.03% by weight, based on the overall composition.

The composition may be free from pentaerythritol tetrastearate and glycerol monostearate, in particular free from demolding agents customarily used for polycarbonate, further free from any demolding agents. Particularly preferably, at least one heat stabilizer (component D) and, as further additive (component E), a flame retardant from the group of the alkali metal, alkaline earth metal and/or ammonium salts of aliphatic or aromatic sulfonic acid, sulfonamide and sulfonimide derivatives, and also optionally a transesterification stabilizer, in particular triisooctyl phosphate, or a UV absorber, are present.

As additive (component E), it is also possible for an impact modifier to be present in compositions according to the invention. Examples of impact modifiers are: acrylate core-shell systems or butadiene rubbers (Paraloid series from DOW Chemical Company); olefin-acrylate copolymers, for example Elvaloy® series from DuPont; silicone acrylate rubbers, for example Metablen® series from Mitsubishi Rayon Co., Ltd.

It will be appreciated that the thermoplastic compositions according to the invention may in principle also contain blend partners. Examples of thermoplastic polymers suitable as blend partners are polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), cyclic polyolefin, poly- or copolyacrylates, poly- or copolymethacrylate, for example poly- or copolymethylmethacrylates (such as PMMA), and also copolymers with styrene, for example transparent polystyrene-acrylonitrile (PSAN), thermoplastic polyurethanes and/or polymers based on cyclic olefins (e.g. TOPAS®, a commercial product from Ticona).

The compositions according to the invention, containing components A to C (or Cl) and optionally D and/or E and also optionally blend partners, are produced by standard incorporation processes via combination, mixing and homogenization of the individual constituents, especially with the homogenization preferably taking place in the melt under the action of shear forces. Combination and mixing is optionally effected prior to melt homogenization using powder pre-mixes.

It is also possible to use premixes of pellets, or of pellets and powders, with components B, C and optionally D and E.

It is also possible to use pre-mixes produced from solutions of the mixture components in suitable solvents where homogenization is optionally effected in solution and the solvent is then removed.

In particular, the components B to E of the composition according to the invention may be introduced into the polycarbonate here by known processes or in the form of masterbatch.

Preference is given to the use of masterbatches to introduce components B to E, individually or in a mixture.

In this connection, the composition according to the invention can be combined, mixed, homogenized and subsequently extruded in customary apparatuses such as screw extruders (ZSK twin-screw extruders for example), kneaders or Brabender or Banbury mills. The extrudate may be cooled and comminuted after extrusion. It is also possible to premix individual components and then to add the remaining starting materials individually and/or likewise mixed.

The combining and mixing of a pre-mix in the melt may also be effected in the plasticizing unit of an injection molding machine. In this case, the melt is directly converted into a molded article in the subsequent step.

The compositions according to the invention can be processed in a customary manner in standard machines, for example in extruders or injection molding machines, to give any molded articles, for example films, sheets or bottles.

Production of the moldings is preferably effected by injection molding, extrusion or from solution in a casting process.

For example, the compositions according to the invention have at least one of the following properties:
an elongation at break according to DIN EN ISO 527-1/-2:1996 of ≥1% to ≤5%
a tensile stress at yield according to DIN EN ISO 527-1/-2:1996 of ≥58 N/mm², preferably ≥60 N/mm² to ≤150 N/mm²
an elongation at yield according to DIN EN ISO 527-1/-2:1996 of ≥1% to ≤5%
a modulus of elasticity according to DIN EN ISO 527-1/-2:1996 of ≥3500 N/mm² to ≤20 000 N/mm²
a rating in the UL94 fire test (1.5 mm wall thickness) of V0.

The compositions according to the invention are suitable for producing multilayered systems. This involves application of the polycarbonate-containing composition in one or more layer(s) onto a molded article made of a plastics material. Application may be carried out at the same time as or immediately after the molding of the molded body, for example by in-mold coating of a film, coextrusion or multicomponent injection molding. However, application can also take place onto the finished molded base body, e.g. via lamination with a film, insert molding of an existing molded body or via coating from a solution.

The compositions according to the invention are suitable for producing components in the automotive sector, for instance for visors, headlight covers or frames, lenses and collimators or light guides and for producing frame components in the electricals and electronics (EE) and IT sectors, in particular for applications which impose stringent flowability requirements (thin layer applications). Such applications are for example housings, for instance for ultrabooks, or frame/frame parts for LED display technologies, for example OLED displays or LCD displays, or else for electronic ink devices.

Further applications are housing parts of mobile communication terminals, such as smartphones, tablets, ultrabooks, notebooks or laptops, but also housing parts for navigation devices, smartwatches or heart rate monitors, and also for electrical applications in thin-wall designs, for example home and industrial networking units and smart meter housing components.

It is a particular feature of the compositions according to the invention that they exhibit exceptional rheological and optical properties on account of the presence of component C. They are therefore particularly suitable for the production of sophisticated injection molded parts, particularly for thin-wall applications where good flowability is required. Examples of such applications are ultrabook housing parts, laptop covers, headlight covers, LED applications or components for electricals and electronics applications. Thin-wall applications are preferably applications where there are wall thicknesses of less than 3 mm, more preferably of less than 2.5 mm, more preferably still of less than 2.0 mm, very particularly preferably of less than 1.5 mm. In this specific case, “wall thickness” is defined as the thickness of the wall perpendicular to the surface of the molding having the greatest extent, the stated thickness being present over at least 60%, preferably over at least 75%, more preferably over at least 90%, particularly preferably over the entire surface.

The moldings, consisting of the compositions according to the invention or comprising these, including the moldings constituting a layer of a multilayered system or an element of an abovementioned component and made from (“consisting of”) these compositions according to the invention, are likewise subject matter of this application.

The embodiments described hereinabove for the compositions according to the invention also apply—where applicable—to the use according to the invention.

The examples which follow are intended to illustrate the invention but without limiting said invention.

### EXAMPLES

### 1. Description of Raw Materials and Test Methods

The polycarbonate-based compositions described in the following examples were produced by compounding on a Berstorff ZE 25 extruder at a throughput of 10 kg/h. The melt temperature was 275° C.

Component A-1: Linear polycarbonate based on bisphenol A having a melt volume-flow rate MVR of 9.5 cm³/(10 min) (according to ISO 1133:2012-03, at a test temperature of 300° C. and with 1.2 kg load).

Component A-2: Linear polycarbonate based on bisphenol A having a melt volume-flow rate MVR of 6 cm³/(10 min) (according to ISO 1133:2012-03, at a test temperature of 300° C. and with 1.2 kg load).

Components A-1 and A-2 each contain 250 ppm of triphenylphosphine from BASF SE as component D.

Component A-3: Linear polycarbonate powder based on bisphenol A having a melt volume-flow rate MVR of 6 cm³/(10 min) (according to ISO 1133:2012-03, at a test temperature of 300° C. and with 1.2 kg load).

Component B-1: CS108F-14P, chopped short glass fibers (non-binding) from 3B having an average fiber diameter of 14 μm and an average fiber length of 4 0 mm prior to compounding, the fiber dimensions of these and of the following components being determined by light microscopy.

Component B-2: CS 7942, chopped short glass fibers (binding) from Lanxess Deutschland GmbH having an average fiber diameter of 14 μm and an average fiber length of 4 5 mm prior to compounding.

Component B-3: CF Tenax HT 493 carbon fibers, chopped short carbon fibers from Toho Tenax Europe GmbH Germany with application of a thermoplastic preparation and with an average cut length of 6 mm prior to compounding.

Component B-4: CF Tairyfil CS2516 carbon fibers, chopped short carbon fibers from Dow Aksa (Turkey) having an average length of 6 mm prior to compounding.

Component B-5: CF Aksaka AC3101 carbon fibers, chopped short carbon fibers from Dow Aksa (Turkey) having an average length of 6 mm prior to compounding.

Component C: Epoxidized soybean oil (“D65 soybean oil”) from Avokal GmbH, Wuppertal, having an acid number of ≤0.5 mg KOH/g, determined by DIN EN ISO 2114:2006-11, an oxirane value (epoxide oxygen EO, calculated from the epoxide number EEW, indicates how many grams of oxygen are present per 100 g of oil; EEW determined in accordance with DIN 16945:1987-09) of ≥6.3 g of O₂/100 g. Predominantly completely epoxidized triacylglycerols, which are a mixture of triesters of glycerol with oleic acid, linoleic acid, linolenic acid, palmitic acid and/or stearic acid.

Component E: Potassium perfluoro-1-butanesulfonate, commercially available as Bayowet C₄ from Lanxess AG, Leverkusen, Germany, CAS no. 29420-49-3.

Melt volume-flow rate (MVR) was determined in accordance with ISO 1133:2012-03 (predominantly at a test temperature of 300° C., mass 1.2 kg) using a Zwick 4106 instrument from Zwick Roell. In addition, the MVR value was measured after a preheating time of 20 minutes (IMVR20′). This is a measure of melt stability under elevated thermal stress.

Shear viscosity (melt viscosity) was determined in accordance with ISO 11443:2005 with a Göttfert Visco-Robo 45.00 instrument.

Solution viscosity eta rel was determined in accordance with ISO 1628-4:1999-03 with an Ubbelohde viscometer. To this end, the pellets were dissolved and the fillers were removed by filtration. The filtrate was concentrated and dried. The film obtained was used for the measurement of the solution viscosity.

Tensile modulus of elasticity (“modulus of elasticity”) was measured in accordance with ISO 527-1/-2:1996-04 on single-side-injected dumbbells having a core measuring 80 mm×10 mm×4 mm.

Elongation at break and tensile stress at yield, elongation at yield, tensile strength, tensile stress at break, elongation at break, nominal elongation at break were determined by tensile test in accordance with DIN EN ISO 527-1/-2:1996.

The flammability of the samples investigated was also assessed and classified, specifically according to UL94. To this end, test specimens measuring 125 mm×13 mm×d (mm) were produced, where the thickness d is the smallest wall thickness in the intended application. A V0 classification means that the flame self-extinguishes after not more than 10 s. There are no burning drips. Afterglow after second flame contact has a duration of not more than 30 s.

The specimen plaques were in each case produced by injection molding at the melt temperatures reported in the tables which follow.

### 2. Compositions

TABLE 1
Compounds containing glass fibers

| Formulation | | C1 | 1 | 2 | 3 | 4 |
|---|---|---|---|---|---|---|
| A-1 | % by weight | 79.35 | 79.35 | 79.35 | 79.35 | 79.35 |
| A-2 | % by weight | 3.65 | 3.65 | 3.65 | 3.65 | 3.65 |
| A-3 | % by weight | 6.8 | 6.6 | 6.4 | 6.2 | 6 |
| B-1 | % by weight | 10 | 10 | 10 | 10 | 10 |
| B-2 | % by weight | — | — | — | — | — |
| C | % by weight | — | 0.2 | 0.4 | 0.6 | 0.8 |
| E | % by weight | 0.2 | 0.2 | 0.2 | 0.2 | 0.2 |
| Tests: | | | | | | |
| ηᵣₑₗ of pellets (of film) | | 1.284 | 1.279 | 1.279 | 1.278 | 1.275 |
| MVR | cm³/(10 min) | 6.4 | 8.4 | 10.0 | 11.2 | 12.4 |
| IMVR20′ | cm³/(10 min) | 6.6 | 9.7 | 12.6 | 14.8 | 17.1 |
| Delta MVR/IMVR20′ | | 0.2 | 1.3 | 2.6 | 3.6 | 4.7 |
| Melt visc. at 280° C. | | | | | | |
| eta 50 | Pa · s | 1166 | 1032 | 972 | 911 | 767 |
| eta 100 | Pa · s | 967 | 906 | 832 | 776 | 648 |
| eta 200 | Pa · s | 787 | 774 | 695 | 661 | 558 |
| eta 500 | Pa · s | 585 | 581 | 501 | 486 | 417 |
| eta 1000 | Pa · s | 440 | 440 | 376 | 356 | 321 |
| eta 1500 | Pa · s | 354 | 357 | 307 | 300 | 270 |
| eta 5000 | Pa · s | 167 | 166 | 149 | 145 | 135 |
| Melt visc. at 300° C. | | | | | | |
| eta 50 | Pa · s | 753 | 537 | 537 | 469 | 380 |
| eta 100 | Pa · s | 628 | 471 | 491 | 414 | 339 |
| eta 200 | Pa · s | 532 | 424 | 427 | 355 | 303 |
| eta 500 | Pa · s | 416 | 331 | 347 | 279 | 232 |
| eta 1000 | Pa · s | 335 | 268 | 276 | 229 | 199 |
| eta 1500 | Pa · s | 271 | 228 | 240 | 198 | 169 |
| eta 5000 | Pa · s | 130 | 120 | 116 | 107 | 92 |
| Melt visc. at 320° C. | | | | | | |
| eta 50 | Pa · s | 501 | 331 | 331 | 339 | 234 |
| eta 100 | Pa · s | 447 | 297 | 288 | 295 | 213 |
| eta 200 | Pa · s | 380 | 252 | 251 | 247 | 186 |
| eta 500 | Pa · s | 293 | 204 | 207 | 195 | 150 |
| eta 1000 | Pa · s | 230 | 172 | 170 | 154 | 125 |
| eta 1500 | Pa · s | 198 | 152 | 150 | 132 | 111 |
| eta 5000 | Pa · s | 108 | 87 | 89 | 76 | 69 |
| Tensile test | | | | | | |
| Tensile stress at yield | N/mm² | 63 | 63 | 64 | 65 | 66 |
| Elongation at yield | % | 5.1 | 5 | 5.1 | 5 | 4.9 |
| Tensile strength | N/mm² | 46 | 45 | 47 | 47 | 47 |
| Elongation at break | % | 17 | 14 | 17 | 14 | 14 |
| Modulus of elasticity | N/mm² | 3630 | 3713 | 3710 | 3867 | 3893 |
| UL94V in 1.5 mm | | | | | | |
| (48 h, 23° C.) | | V0 | V0 | V0 | V0 | V0 |
| (7 d, 70° C.) | | V2 | V0 | V0 | V0 | V0 |
| Overall rating | | V2 | V0 | V0 | V0 | V0 |
| UL94 5V | | | | | | |
| Overall assessment UL94 | | 94-5VA | 94-5VA | 94-5VA | 94-5VB | 94-5VB |
| 5V | | | | | | |
| Formulation | | C2 | 5 | 6 | 7 | 8 |
| A-1 | % by weight | 70 | 70 | 70 | 70 | 70 |
| A-2 | % by weight | 3.00 | 3.00 | 3.00 | 3.00 | 3.00 |
| A-3 | % by weight | 6.84 | 6.64 | 6.44 | 6.24 | 6.04 |
| B-1 | % by weight | — | — | — | — | — |
| B-2 | % by weight | 20 | 20 | 20 | 20 | 20 |
| C | % by weight | — | 0.2 | 0.4 | 0.6 | 0.8 |
| E | % by weight | 0.16 | 0.16 | 0.16 | 0.16 | 0.16 |
| Tests: | | | | | | |
| ηᵣₑₗ of pellets (of film) | | 1.277 | 1.273 | 1.275 | 1.269 | 1.270 |
| MVR | cm³/(10 min) | 6.1 | 7.3 | 8.4 | 9.2 | 9.7 |
| IMVR20′ | cm³/(10 min) | 6.5 | 7.9 | 9.4 | 10.8 | 12.2 |
| Delta MVR/IMVR20′ | | 0.4 | 0.6 | 1.0 | 1.6 | 2.5 |
| Melt visc. at 280° C. | | | | | | |
| eta 50 | Pa · s | 1126 | 1172 | 1247 | 1040 | 1098 |
| eta 100 | Pa · s | 932 | 902 | 935 | 796 | 815 |
| eta 200 | Pa · s | 777 | 714 | 728 | 616 | 632 |
| eta 500 | Pa · s | 575 | 535 | 555 | 461 | 475 |
| eta 1000 | Pa · s | 432 | 397 | 413 | 349 | 364 |
| eta 1500 | Pa · s | 352 | 326 | 334 | 288 | 300 |
| eta 5000 | Pa · s | 182 | 153 | 156 | 142 | 158 |
| Melt visc. at 300° C. | | | | | | |
| eta 50 | Pa · s | 646 | 468 | 603 | 399 | 506 |
| eta 100 | Pa · s | 550 | 417 | 468 | 341 | 407 |
| eta 200 | Pa · s | 454 | 347 | 371 | 288 | 343 |
| eta 500 | Pa · s | 338 | 270 | 290 | 217 | 265 |
| eta 1000 | Pa · s | 274 | 216 | 228 | 178 | 218 |
| eta 1500 | Pa · s | 233 | 188 | 197 | 157 | 187 |
| eta 5000 | Pa · s | 121 | 106 | 109 | 93 | 106 |
| Melt visc. at 320° C. | | | | | | |
| eta 50 | Pa · s | 339 | 302 | 263 | 240 | 269 |
| eta 100 | Pa · s | 298 | 275 | 229 | 219 | 204 |
| eta 200 | Pa · s | 253 | 242 | 204 | 188 | 171 |
| eta 500 | Pa · s | 196 | 190 | 178 | 152 | 138 |
| eta 1000 | Pa · s | 158 | 149 | 156 | 122 | 111 |
| eta 1500 | Pa · s | 141 | 133 | 141 | 104 | 103 |
| eta 5000 | Pa · s | 79 | 79 | 83 | 66 | 65 |
| Tensile test | | | | | | |
| Tensile stress at yield | N/mm² | — | 100 | 98 | 103 | 102 |
| Elongation at yield | % | — | 3.2 | 3.3 | 3.2 | 3.3 |
| Tensile strength | N/mm² | 95 | 99 | 98 | 102 | 101 |
| Elongation at break | % | 3 | 3.2 | 3.5 | 3.4 | 3.4 |
| Modulus of elasticity | N/mm² | 5615 | 5611 | 5330 | 5685 | 5629 |
| UL94V in 1.5 mm | | | | | | |
| (48 h, 23° C.) | | V0 | V0 | V0 | V0 | V0 |
| (7 d, 70° C.) | | V0 | V0 | V0 | V0 | V0 |
| Overall rating | | V0 | V0 | V0 | V0 | V0 |
| UL94 5V | | | | | | |
| Overall assessment UL94 | | 94-5VA | 94-5VA | 94-5VA | 94-5VA | 94-5VA |
| 5V | | | | | | |

Comparative examples C₁ and C₂, which do not contain component C, have a much lower flowability than examples 1 to 4 and 5 to 8. This is shown both in the MVR values and in the shear viscosities at different measurement temperatures and different shear rates.

The very good flame retardancy properties and the good mechanical properties, determined by tensile test, are retained. The flowability of the molten compositions increases as the proportion of component C rises. A comparable situation can be ascertained for the following series of tests, the compositions starting from table 5 being free of flame retardant.

TABLE 2
Compounds containing carbon fibers

| Formulation | | C3 | 9 | 10 | C4 | 11 | 12 |
|---|---|---|---|---|---|---|---|
| A-1 | % by weight | 79.35 | 79.35 | 79.35 | 70 | 70 | 70 |
| A-2 | % by weight | 3.65 | 3.65 | 3.65 | 3.00 | 3.00 | 3.00 |
| A-3 | % by weight | 6.8 | 6.6 | 6.4 | 6.84 | 6.64 | 6.44 |
| B-3 | % by weight | 10 | 10 | 10 | 20 | 20 | 20 |
| C | % by weight | — | 0.2 | 0.4 | — | 0.2 | 0.4 |
| E | % by weight | 0.2 | 0.2 | 0.2 | 0.16 | 0.16 | 0.16 |
| Tests: | | | | | | | |
| ηᵣₑₗ of pellets (of film) | | 1.268 | 1.267 | 1.270 | 1.253 | 1.248 | 1.246 |
| MVR | cm³/(10 min) | 6.0 | 7.4 | 8.1 | 7.7 | 8.4 | 10.6 |
| IMVR20′ | cm³/(10 min) | 8.5 | 11.8 | 9.9 | 7.0 | 9.1 | 11.2 |
| Delta MVR/IMVR20′ | | 2.5 | 4.4 | 1.8 | −0.7 | 0.7 | 0.6 |
| Melt visc. at 280° C. | | | | | | | |
| eta 50 | Pa · s | 1081 | 955 | 758 | 1011 | 941 | 912 |
| eta 100 | Pa · s | 941 | 849 | 723 | 870 | 828 | 786 |
| eta 200 | Pa · s | 811 | 726 | 649 | 748 | 705 | 674 |
| eta 500 | Pa · s | 612 | 549 | 504 | 562 | 531 | 501 |
| eta 1000 | Pa · s | 467 | 422 | 394 | 427 | 399 | 376 |
| eta 1500 | Pa · s | 378 | 349 | 329 | 352 | 332 | 313 |
| eta 5000 | Pa · s | 225 | 162 | 200 | 167 | 155 | 152 |
| Melt visc. at 300° C. | | | | | | | |
| eta 50 | Pa · s | 604 | 562 | 501 | 547 | 505 | 365 |
| eta 100 | Pa · s | 533 | 457 | 456 | 470 | 470 | 337 |
| eta 200 | Pa · s | 474 | 380 | 400 | 400 | 404 | 298 |
| eta 500 | Pa · s | 364 | 279 | 314 | 316 | 321 | 243 |
| eta 1000 | Pa · s | 287 | 230 | 250 | 252 | 253 | 202 |
| eta 1500 | Pa · s | 247 | 196 | 213 | 213 | 213 | 177 |
| eta 5000 | Pa · s | 129 | 107 | 118 | 118 | 118 | 102 |
| Melt visc. at 320° C. | | | | | | | |
| eta 50 | Pa · s | 365 | 337 | 295 | 337 | 295 | 154 |
| eta 100 | Pa · s | 313 | 288 | 246 | 295 | 274 | 133 |
| eta 200 | Pa · s | 277 | 253 | 225 | 253 | 239 | 130 |
| eta 500 | Pa · s | 230 | 202 | 178 | 204 | 192 | 115 |
| eta 1000 | Pa · s | 188 | 166 | 151 | 169 | 166 | 104 |
| eta 1500 | Pa · s | 163 | 143 | 133 | 148 | 145 | 95 |
| eta 5000 | Pa · s | 98 | 86 | 80 | 88 | 84 | 65 |
| Tensile test | | | | | | | |
| Tear strength | N/mm² | 112 | 116 | 116 | 146 | 149 | 137 |
| Elongation at break | % | 2.6 | 2.7 | 2.7 | 2.1 | 1.9 | 1.6 |
| Modulus of elasticity | N/mm² | 7330 | 7547 | 7545 | 12500 | 12860 | 12965 |
| UL94V in 1.5 mm | | | | | | | |
| (48 h, 23° C.) | | V0 | V1 | V1 | V1 | V1 | V1 |
| (7 d, 70° C.) | | V1 | V1 | V1 | V1 | V1 | V1 |
| Overall rating | | V1 | V1 | V1 | V1 | V1 | V1 |

f: fail

The V0 rating in example C₃ is considered an outlier. The afterflame time of this comparative example was longer than that of example 9, which was analogous but according to the invention.

TABLE 3
Compounds containing carbon fibers

| Formulation | | C5 | 13 | 14 | C6 | 15 | 16 |
|---|---|---|---|---|---|---|---|
| A-1 | % by weight | 79.35 | 79.35 | 79.35 | 70 | 70 | 70 |
| A-2 | % by weight | 3.65 | 3.65 | 3.65 | 3.00 | 3.00 | 3.00 |
| A-3 | % by weight | 6.8 | 6.6 | 6.4 | 6.84 | 6.64 | 6.44 |
| B-4 | % by weight | 10 | 10 | 10 | 20 | 20 | 20 |
| C | % by weight | — | 0.2 | 0.4 | — | 0.2 | 0.4 |
| E | % by weight | 0.2 | 0.2 | 0.2 | 0.16 | 0.16 | 0.16 |
| Tests: | | | | | | | |
| ηᵣₑₗ of pellets (of film) | | 1.276 | 1.278 | 1.273 | 1.279 | 1.273 | 1.269 |
| MVR | cm³/(10 min) | 5.9 | 6.5 | 6.8 | 4.3 | 4.8 | 5.1 |
| IMVR20′ | cm³/(10 min) | 6.9 | 8.1 | 9.2 | 5.1 | 6.2 | 6.6 |
| Delta MVR/IMVR20′ | | 1.0 | 1.6 | 2.4 | 0.8 | 1.4 | 1.5 |
| Melt visc. at 280° C. | | | | | | | |
| eta 50 | Pa · s | 1249 | 997 | 926 | 1067 | 1221 | 1137 |
| eta 100 | Pa · s | 1074 | 884 | 835 | 948 | 1102 | 962 |
| eta 200 | Pa · s | 905 | 769 | 726 | 828 | 891 | 807 |
| eta 500 | Pa · s | 672 | 585 | 562 | 622 | 630 | 584 |
| eta 1000 | Pa · s | 497 | 449 | 432 | 488 | 468 | 448 |
| eta 1500 | Pa · s | 398 | 367 | 353 | 410 | 382 | 366 |
| eta 5000 | Pa · s | 197 | 168 | 162 | 202 | 176 | 169 |
| Melt visc. at 300° C. | | | | | | | |
| eta 50 | Pa · s | 772 | 525 | 479 | 632 | 688 | 590 |
| eta 100 | Pa · s | 667 | 491 | 449 | 583 | 653 | 533 |
| eta 200 | Pa · s | 572 | 449 | 404 | 519 | 562 | 474 |
| eta 500 | Pa · s | 438 | 361 | 330 | 406 | 425 | 371 |
| eta 1000 | Pa · s | 339 | 284 | 258 | 306 | 317 | 283 |
| eta 1500 | Pa · s | 283 | 240 | 218 | 260 | 263 | 235 |
| eta 5000 | Pa · s | 139 | 123 | 114 | 136 | 135 | 124 |
| Melt visc. at 320° C. | | | | | | | |
| eta 50 | Pa · s | 398 | 251 | 267 | 326 | 372 | 312 |
| eta 100 | Pa · s | 358 | 246 | 260 | 309 | 358 | 295 |
| eta 200 | Pa · s | 319 | 239 | 246 | 291 | 326 | 270 |
| eta 500 | Pa · s | 250 | 205 | 205 | 244 | 264 | 223 |
| eta 1000 | Pa · s | 202 | 172 | 169 | 199 | 212 | 183 |
| eta 1500 | Pa · s | 173 | 147 | 146 | 173 | 181 | 158 |
| eta 5000 | Pa · s | 97 | 85 | 87 | 99 | 101 | 90 |
| Tensile test | | | | | | | |
| Tensile stress at yield | N/mm² | 113 | 113 | 114 | 144 | 146 | n.m. |
| Elongation at yield | % | 3.4 | 3.4 | 3.3 | 2.7 | 2.7 | n.m. |
| Tear strength | N/mm² | 111 | 112 | 112 | 143 | 145 | 147 |
| Elongation at break | % | 3.8 | 3.9 | 3.7 | 2.5 | 2.5 | 2.3 |
| Modulus of elasticity | N/mm² | 7504 | 7445 | 7527 | 12390 | 12764 | 13012 |
| UL94V in 1.5 mm | | | | | | | |
| (48 h, 23° C.) | | V0 | V1 | V0 | V1 | V0 | V1 |
| (7 d, 70° C.) | | V0 | V0 | V0 | V1 | V0 | V0 |
| Overall rating | | V0 | V1 | V0 | V1 | V0 | V1 |

n.m.: not measured

TABLE 4
Compounds containing carbon fibers

| Formulation | | C7 | 17 | 18 | C8 | 19 | 20 |
|---|---|---|---|---|---|---|---|
| A-1 | % by weight | 79.35 | 79.35 | 79.35 | 70 | 70 | 70 |
| A-2 | % by weight | 3.65 | 3.65 | 3.65 | 3.00 | 3.00 | 3.00 |
| A-3 | % by weight | 6.8 | 6.6 | 6.4 | 6.84 | 6.64 | 6.44 |
| B-5 | % by weight | 10 | 10 | 10 | 20 | 20 | 20 |
| C | % by weight | — | 0.2 | 0.4 | — | 0.2 | 0.4 |
| E | % by weight | 0.2 | 0.2 | 0.2 | 0.16 | 0.16 | 0.16 |
| Tests: | | | | | | | |
| ηᵣₑₗ of pellets (of film) | | 1.275 | 1.273 | 1.272 | 1.270 | 1.267 | 1.264 |
| MVR | cm³/(10 min) | 6.1 | 7.1 | 8.4 | 3.4 | 4.3 | 4.6 |
| IMVR20′ | cm³/(10 min) | 6.1 | 8.7 | 10.9 | 4.0 | 6.5 | 7.4 |
| Delta MVR/IMVR20′ | | 0.0 | 1.6 | 2.5 | 0.6 | 2.2 | 2.8 |
| Melt visc. at 280° C. | | | | | | | |
| eta 50 | Pa · s | 1123 | 702 | 941 | 1207 | 1067 | 856 |
| eta 100 | Pa · s | 990 | 667 | 828 | 1074 | 934 | 779 |
| eta 200 | Pa · s | 839 | 600 | 688 | 905 | 793 | 691 |
| eta 500 | Pa · s | 633 | 484 | 522 | 661 | 571 | 525 |
| eta 1000 | Pa · s | 478 | 380 | 403 | 482 | 435 | 407 |
| eta 1500 | Pa · s | 388 | 318 | 334 | 377 | 351 | 338 |
| eta 5000 | Pa · s | 178 | 153 | 158 | 183 | 165 | 162 |
| Melt visc. at 300° C. | | | | | | | |
| eta 50 | Pa · s | 624 | 323 | 365 | 702 | 421 | 267 |
| eta 100 | Pa · s | 540 | 309 | 351 | 618 | 421 | 263 |
| eta 200 | Pa · s | 474 | 288 | 319 | 526 | 368 | 260 |
| eta 500 | Pa · s | 379 | 233 | 261 | 404 | 293 | 233 |
| eta 1000 | Pa · s | 293 | 200 | 213 | 313 | 235 | 193 |
| eta 1500 | Pa · s | 247 | 178 | 183 | 267 | 199 | 176 |
| eta 5000 | Pa · s | 131 | 101 | 105 | 142 | 118 | 102 |
| Melt visc. at 320° C. | | | | | | | |
| eta 50 | Pa · s | 379 | 191 | 211 | 407 | 275 | 135 |
| eta 100 | Pa · s | 337 | 175 | 204 | 372 | 253 | 133 |
| eta 200 | Pa · s | 291 | 158 | 186 | 312 | 218 | 127 |
| eta 500 | Pa · s | 236 | 146 | 156 | 236 | 168 | 120 |
| eta 1000 | Pa · s | 194 | 126 | 129 | 188 | 138 | 103 |
| eta 1500 | Pa · s | 169 | 116 | 116 | 163 | 120 | 94 |
| eta 5000 | Pa · s | 102 | 76 | 73 | 98 | 75 | 60 |
| Tensile test | | | | | | | |
| Tensile stress at yield | N/mm² | — | — | — | — | — | — |
| Elongation at yield | % | — | — | — | — | — | — |
| Tear strength | N/mm² | 106 | 105 | 106 | 128 | 133 | 132 |
| Elongation at break | % | 2.5 | 2.5 | 2.5 | 1.4 | 1.4 | 1.4 |
| Modulus of elasticity | N/mm² | 7508 | 7495 | 7495 | 13056 | 13542 | 13648 |
| UL94V in 1.5 mm | | | | | | | |
| (48 h, 23° C.) | | V0 | V0 | V1 | V0 | V1 | V0 |
| (7 d, 70° C.) | | V1 | V0 | V0 | V0 | V0 | V0 |
| Overall rating | | V1 | V0 | V1 | V0 | V1 | V0 |

TABLE 5
Compounds containing glass fibers without flame retardant

| Formulation | | C9 | 21 | 22 | 23 | 24 | C10 | 25 | 26 | 27 | 28 |
|---|---|---|---|---|---|---|---|---|---|---|---|
| A-1 | % by weight | 79.35 | 79.35 | 79.35 | 79.35 | 79.35 | 70.00 | 70.00 | 70.00 | 70.00 | 70.00 |
| A-2 | % by weight | 3.65 | 3.65 | 3.65 | 3.65 | 3.65 | 3.00 | 3.00 | 3.00 | 3.00 | 3.00 |
| A-3 | % by weight | 7.00 | 6.80 | 6.60 | 6.40 | 6.20 | 7.00 | 6.80 | 6.60 | 6.40 | 6.20 |
| B-1 | % by weight | 10.00 | 10.00 | 10.00 | 10.00 | 10.00 | | | | | |
| B-2 | % by weight | | | | | | 20.00 | 20.00 | 20.00 | 20.00 | 20.00 |
| C | % by weight | | 0.20 | 0.40 | 0.60 | 0.80 | | 0.20 | 0.40 | 0.60 | 0.80 |
| Tests: | | | | | | | | | | | |
| MVR | cm³/(10 min) | 5.5 | 5.8 | 6.1 | 6.5 | 6.6 | 4.7 | 5.0 | 5.3 | 5.5 | 6.0 |
| IMVR20′ | cm³/(10 min) | 5.6 | 6.3 | 6.8 | 7.3 | 8.0 | 5.1 | 5.6 | 6.0 | 6.7 | 7.1 |
| Delta MVR/IMVR20′ | | 0.1 | 0.5 | 0.7 | 0.8 | 1.4 | 0.4 | 0.6 | 0.7 | 1.2 | 1.1 |
| Vicat VST B50 | ° C. | 146.8 | 144.6 | 143.6 | 141.5 | 139.7 | 149.9 | 148.1 | 145.7 | 144.5 | 142.7 |
| Melt visc. at 280° C. | | | | | | | | | | | |
| eta 50 | Pa · s | 1439 | 1365 | 1330 | 1307 | 1254 | 1533 | 1737 | 1580 | 1565 | 1422 |
| eta 100 | Pa · s | 1230 | 1152 | 1133 | 1124 | 1065 | 1313 | 1365 | 1264 | 1296 | 1173 |
| eta 200 | Pa · s | 1036 | 972 | 948 | 937 | 892 | 1104 | 1108 | 1024 | 1012 | 963 |
| eta 500 | Pa · s | 784 | 730 | 706 | 703 | 675 | 802 | 762 | 713 | 734 | 693 |
| eta 1000 | Pa · s | 570 | 526 | 514 | 514 | 487 | 578 | 554 | 522 | 540 | 517 |
| eta 1500 | Pa · s | 445 | 415 | 403 | 401 | 387 | 455 | 435 | 420 | 427 | 415 |
| eta 5000 | Pa · s | 196 | 182 | 177 | 176 | 174 | 220 | 189 | 180 | 189 | 200 |
| Melt visc. at 300° C. | | | | | | | | | | | |
| eta 50 | Pa · s | 944 | 818 | 748 | 764 | 748 | 940 | 992 | 957 | 982 | 968 |
| eta 100 | Pa · s | 754 | 721 | 705 | 673 | 657 | 741 | 781 | 758 | 772 | 708 |
| eta 200 | Pa · s | 636 | 610 | 599 | 560 | 554 | 615 | 626 | 595 | 608 | 571 |
| eta 500 | Pa · s | 488 | 476 | 464 | 438 | 431 | 472 | 463 | 445 | 452 | 430 |
| eta 1000 | Pa · s | 383 | 374 | 366 | 349 | 339 | 363 | 346 | 335 | 336 | 325 |
| eta 1500 | Pa · s | 317 | 315 | 300 | 284 | 280 | 306 | 288 | 277 | 280 | 271 |
| eta 5000 | Pa · s | 149 | 149 | 143 | 139 | 137 | 150 | 140 | 139 | 139 | 136 |
| Melt visc. at 320° C. | | | | | | | | | | | |
| eta 50 | Pa · s | 543 | 542 | 457 | 515 | 529 | 615 | 596 | 580 | 605 | 600 |
| eta 100 | Pa · s | 465 | 451 | 444 | 431 | 443 | 525 | 517 | 519 | 523 | 461 |
| eta 200 | Pa · s | 391 | 392 | 377 | 364 | 364 | 403 | 401 | 394 | 394 | 344 |
| eta 500 | Pa · s | 308 | 310 | 301 | 286 | 288 | 304 | 294 | 299 | 288 | 250 |
| eta 1000 | Pa · s | 249 | 254 | 245 | 235 | 236 | 240 | 231 | 238 | 228 | 206 |
| eta 1500 | Pa · s | 218 | 217 | 209 | 200 | 204 | 202 | 195 | 202 | 191 | 176 |
| eta 5000 | Pa · s | 116 | 114 | 111 | 108 | 110 | 111 | 109 | 112 | 107 | 99 |
| Tensile test | | | | | | | | | | | |
| Tensile stress at yield | N/mm² | 60.4 | 61.6 | 61.8 | 62 | 62.2 | 95.3 | n.d. | n.d. | n.d. | n.d. |
| Elongation at yield | % | 5.1 | 5 | 5.1 | 5 | 5 | 3.1 | n.d. | n.d. | n.d. | n.d. |
| Tensile strength | N/mm² | 60.4 | 61.6 | 61.8 | 62 | 62.2 | 94.7 | 93.4 | 96.2 | 95.5 | 97.6 |
| Tensile stress at break | N/mm² | 45.4 | 45.4 | 45.6 | 44.7 | 45 | 94.2 | 93.3 | 96.1 | 95.5 | 97.3 |
| Elongation at break | % | 27.2 | 22.6 | 26.4 | 27.2 | 18.5 | 3 | 2.8 | 2.8 | 2.7 | 2.7 |
| Nominal elongation at | % | 14.9 | 12.9 | 14.5 | 14.8 | 10.8 | 3.5 | 3.3 | 3.4 | 3.3 | 3.3 |
| break | | | | | | | | | | | |
| Modulus of elasticity | N/mm² | 3604 | 3674 | 3625 | 3675 | 3663 | 5440 | 5431 | 5576 | 5518 | 5698 |

TABLE 6
Compounds containing carbon fibers without flame retardant

| Formulation | | C11 | 29 | 30 | C12 | 31 | 32 |
|---|---|---|---|---|---|---|---|
| A-1 | % by weight | 79.35 | 79.35 | 79.35 | 70.00 | 70.00 | 70.00 |
| A-2 | % by weight | 3.65 | 3.65 | 3.65 | 3.00 | 3.00 | 3.00 |
| A-3 | % by weight | 7.00 | 6.80 | 6.60 | 7.00 | 6.80 | 6.60 |
| B-3 | % by weight | 10.00 | 10.00 | 10.00 | 20.00 | 20.00 | 20.00 |
| C | % by weight | | 0.20 | 0.40 | | 0.20 | 0.40 |
| Tests: | | | | | | | |
| MVR | cm³/(10 min) | 5.6 | 5.7 | 6.1 | 4.6 | 4.9 | 5.2 |
| IMVR20′ | cm³/(10 min) | 5.7 | 6.5 | 6.9 | 5.4 | 6.0 | 6.4 |
| Delta MVR/IMVR20′ | | 0.1 | 0.8 | 0.8 | 0.8 | 1.1 | 1.2 |
| Vicat VST B50 | ° C. | 149.6 | 147.5 | 146.4 | 149.4 | 147.9 | 146.2 |
| Melt visc. at 280° C. | | | | | | | |
| eta 50 | Pa · s | 1241 | 1210 | 1150 | 1382 | 1388 | 1308 |
| eta 100 | Pa · s | 1093 | 1069 | 1024 | 1198 | 1204 | 1135 |
| eta 200 | Pa · s | 940 | 916 | 876 | 1014 | 1008 | 956 |
| eta 500 | Pa · s | 694 | 682 | 652 | 720 | 729 | 695 |
| eta 1000 | Pa · s | 517 | 508 | 491 | 524 | 527 | 505 |
| eta 1500 | Pa · s | 417 | 407 | 394 | 419 | 422 | 407 |
| eta 5000 | Pa · s | 181 | 179 | 175 | 190 | 200 | 195 |
| Melt visc. at 300° C. | | | | | | | |
| eta 50 | Pa · s | 662 | 648 | 636 | 734 | 764 | 714 |
| eta 100 | Pa · s | 605 | 588 | 577 | 699 | 669 | 638 |
| eta 200 | Pa · s | 535 | 523 | 513 | 609 | 576 | 559 |
| eta 500 | Pa · s | 419 | 407 | 409 | 470 | 454 | 435 |
| eta 1000 | Pa · s | 331 | 320 | 317 | 350 | 348 | 339 |
| eta 1500 | Pa · s | 281 | 274 | 269 | 290 | 288 | 282 |
| eta 5000 | Pa · s | 148 | 135 | 138 | 147 | 144 | 148 |
| Melt visc. at 320° C. | | | | | | | |
| eta 50 | Pa · s | 333 | 390 | 349 | 352 | 391 | 354 |
| eta 100 | Pa · s | 296 | 350 | 302 | 305 | 348 | 308 |
| eta 200 | Pa · s | 272 | 319 | 288 | 292 | 314 | 286 |
| eta 500 | Pa · s | 230 | 266 | 242 | 241 | 255 | 240 |
| eta 1000 | Pa · s | 191 | 218 | 200 | 204 | 209 | 197 |
| eta 1500 | Pa · s | 166 | 188 | 171 | 185 | 183 | 175 |
| eta 5000 | Pa · s | 100 | 110 | 99 | 95 | 104 | 100 |
| Tensile test | | | | | | | |
| Tensile strength | N/mm² | 98.7 | 102.1 | 99.6 | 127.6 | 125.9 | 127.2 |
| Tensile stress at break | N/mm² | 98.6 | 101.8 | 99.6 | 127.1 | 125.8 | 127.2 |
| Elongation at break | % | 2.1 | 2.1 | 2 | 1.6 | 1.4 | 1.5 |
| Nominal elongation at | % | 2.5 | 2.5 | 2.3 | 2.1 | 2 | 2 |
| break | | | | | | | |
| Modulus of elasticity | N/mm² | 6979 | 7252 | 7220 | 12303 | 12551 | 12488 |

TABLE 7
Compounds containing carbon fibers without flame retardant

| Formulation | | C13 | 33 | 34 | C14 | 35 | 36 |
|---|---|---|---|---|---|---|---|
| A-1 | % by weight | 79.35 | 79.35 | 79.3 | 70.00 | 70.00 | 70.00 |
| A-2 | % by weight | 3.65 | 3.65 | 3.65 | 3.00 | 3.00 | 3.00 |
| A-3 | % by weight | 7.00 | 6.80 | 6.60 | 7.00 | 6.80 | 6.60 |
| B-4 | % by weight | 10.00 | 10.00 | 10.00 | 20.00 | 20.00 | 20.00 |
| C | % by weight | | 0.20 | 0.40 | | 0.20 | 0.40 |
| Tests: | | | | | | | |
| MVR | cm³/(10 min) | 5.5 | 5.6 | 5.7 | 3.8 | 4.3 | 4.5 |
| IMVR20′ | cm³/(10 min) | 5.6 | 6.1 | 6.4 | 4.4 | 4.9 | 5.3 |
| Delta MVR/IMVR20′ | | 0.1 | 0.5 | 0.7 | 0.6 | 0.6 | 0.8 |
| Vicat VST B50 | ° C. | 150.8 | 148.3 | 147.1 | 151.7 | 149.1 | 147.5 |
| Melt visc. at 280° C. | | | | | | | |
| eta 50 | Pa · s | 1270 | 1249 | 1213 | 1572 | 1512 | 1469 |
| eta 100 | Pa · s | 1138 | 1125 | 1078 | 1345 | 1326 | 1268 |
| eta 200 | Pa · s | 977 | 956 | 927 | 1131 | 1124 | 1068 |
| eta 500 | Pa · s | 732 | 720 | 692 | 809 | 807 | 762 |
| eta 1000 | Pa · s | 537 | 532 | 509 | 576 | 576 | 543 |
| eta 1500 | Pa · s | 427 | 421 | 404 | 456 | 454 | 429 |
| eta 5000 | Pa · s | 188 | 185 | 178 | 197 | 196 | 188 |
| Melt visc. at 300° C. | | | | | | | |
| eta 50 | Pa · s | 741 | 612 | 714 | 936 | 855 | 782 |
| eta 100 | Pa · s | 686 | 619 | 635 | 824 | 762 | 698 |
| eta 200 | Pa · s | 609 | 546 | 564 | 711 | 662 | 613 |
| eta 500 | Pa · s | 478 | 433 | 446 | 540 | 510 | 482 |
| eta 1000 | Pa · s | 377 | 340 | 349 | 408 | 384 | 367 |
| eta 1500 | Pa · s | 315 | 286 | 293 | 335 | 317 | 304 |
| eta 5000 | Pa · s | 154 | 141 | 144 | 164 | 155 | 150 |
| Melt visc. at 320° C. | | | | | | | |
| eta 50 | Pa · s | 397 | 417 | 448 | 557 | 537 | 485 |
| eta 100 | Pa · s | 363 | 374 | 409 | 499 | 466 | 432 |
| eta 200 | Pa · s | 335 | 338 | 358 | 433 | 416 | 384 |
| eta 500 | Pa · s | 285 | 286 | 291 | 346 | 332 | 312 |
| eta 1000 | Pa · s | 238 | 232 | 238 | 275 | 269 | 249 |
| eta 1500 | Pa · s | 206 | 195 | 206 | 235 | 228 | 213 |
| eta 5000 | Pa · s | 100 | 100 | 114 | 123 | 110 | 115 |
| Tensile test | | | | | | | |
| Tensile stress at yield | N/mm² | 104 | 104.9 | 106 | n.d. | n.d. | n.d. |
| Elongation at yield | % | 3.2 | 3.2 | 3.1 | n.d. | n.d. | n.d. |
| Tensile strength | N/mm² | 104 | 104.9 | 106 | 136.3 | 134.8 | 136.2 |
| Tensile stress at break | N/mm² | 102.9 | 103.9 | 105.1 | 135.8 | 134.8 | 135.5 |
| Elongation at break | % | 3.6 | 3.5 | 3.4 | 2.2 | 2 | 2 |
| Nominal elongation at | % | 3.5 | 3.5 | 3.4 | 2.6 | 2.5 | 2.5 |
| break | | | | | | | |
| Modulus of elasticity | N/mm² | 6897 | 6790 | 6949 | 12217 | 12384 | 12396 |

n.d.: not determined

TABLE 8
Compounds containing glass fibers without flame retardant

| Formulation | | C15 | 37 | 38 | 39 |
|---|---|---|---|---|---|
| A-1 | % by weight | 59.35 | 59.35 | 59.35 | 59.35 |
| A-2 | % by weight | 3.65 | 3.65 | 3.65 | 3.65 |
| A-3 | % by weight | 7.00 | 6.80 | 6.60 | 6.40 |
| B-1 | % by weight | 30.00 | 30.00 | 30.00 | 30.00 |
| C | % by weight | | 0.20 | 0.40 | 0.60 |
| Tests: | | | | | |
| MVR | cm³/(10 min) | 3.8 | 4.0 | 4.1 | 4.5 |
| IMVR20′ | cm³/(10 min) | 3.9 | 4.1 | 4.3 | 4.7 |
| Delta MVR/IMVR20′ | | 0.1 | 0.1 | 0.2 | 0.2 |
| Vicat VST B50 | ° C. | 148.9 | 146.6 | 145.2 | 144 |
| Melt visc. at 280° C. | | | | | |
| eta 100 | Pa · s | 1543 | 1541 | 1533 | 1442 |
| eta 200 | Pa · s | 1265 | 1269 | 1248 | 1173 |
| eta 500 | Pa · s | 900 | 904 | 892 | 805 |
| eta 1000 | Pa · s | 626 | 616 | 598 | 572 |
| eta 1500 | Pa · s | 488 | 490 | 473 | 457 |
| eta 5000 | Pa · s | 208 | 207 | 210 | 199 |
| Melt visc, at 300° C. | | | | | |
| eta 50 | Pa · s | 1088 | 1040 | 1028 | 1069 |
| eta 100 | Pa · s | 915 | 860 | 849 | 858 |
| eta 200 | Pa · s | 764 | 717 | 711 | 691 |
| eta 500 | Pa · s | 571 | 537 | 532 | 517 |
| eta 1000 | Pa · s | 439 | 402 | 399 | 397 |
| eta 1500 | Pa · s | 353 | 319 | 321 | 313 |
| eta 5000 | Pa · s | 170 | 160 | 158 | 156 |
| Tensile test | | | | | |
| Tensile stress at yield | N/mm² | 62.6 | 63.2 | 63 | 62.2 |
| Elongation at yield | % | 2.2 | 2.7 | 2.7 | 3.0 |
| Tensile strength | N/mm² | 62.6 | 63.2 | 63 | 62.2 |
| Tensile stress at break | N/mm² | 61.3 | 62 | 61.9 | 60.8 |
| Elongation at break | % | 2.3 | 2.8 | 2.9 | 3.2 |
| Nominal elongation at | % | 2.6 | 3.1 | 3.0 | 3.3 |
| break | | | | | |
| Modulus of elasticity | N/mm² | 8015 | 8137 | 8189 | 7947 |

TABLE 9
Compounds containing glass fibers without flame retardant

| Formulation | | V16 | 40 | 41 |
|---|---|---|---|---|
| A-1 | % by weight | 49.35 | 49.35 | 49.35 |
| A-2 | % by weight | 3.65 | 3.65 | 3.65 |
| A-3 | % by weight | 7.00 | 6.80 | 6.60 |
| B-1 | % by weight | 40.00 | 40.00 | 40.00 |
| C | % by weight | | 0.20 | 0.40 |
| Tests: | | | | |
| MVR | cm³/(10 min) | 2.7 | 3.3 | 3.1 |
| IMVR20′ | cm³/(10 min) | 2.9 | 3.4 | 2.9 |
| Delta MVR/IMVR20′ | | 0.2 | 0.1 | −0.2 |
| Vicat VST B50 | ° C. | 148.1 | 146 | 144.3 |
| Melt visc. at 280° C. | | | | |
| eta 50 | Pa · s | 2178 | 2069 | 2023 |
| eta 100 | Pa · s | 1776 | 1674 | 1621 |
| eta 200 | Pa · s | 1441 | 1335 | 1321 |
| eta 500 | Pa · s | 997 | 940 | 921 |
| eta 1000 | Pa · s | 661 | 620 | 612 |
| eta 1500 | Pa · s | 525 | 486 | 476 |
| eta 5000 | Pa · s | 223 | 211 | 207 |
| Tensile test | | | | |
| Tensile stress at yield | N/mm² | 0 | 58.7 | 58.6 |
| Elongation at yield | % | 0 | 1.3 | 1.2 |
| Tensile strength | N/mm² | 62.3 | 58.3 | 58.9 |
| Tensile stress at break | N/mm² | 61.6 | 57.3 | 57.9 |
| Elongation at break | % | 1.0 | 1.2 | 1.2 |
| Nominal elongation at | % | 1.5 | 1.7 | 1.6 |
| break | | | | |
| Modulus of elasticity | N/mm² | 10372 | 10276 | 10349 |

TABLE 10
Compounds containing carbon fibers without flame retardant

| Formulation | | C17 | 42 | 43 |
|---|---|---|---|---|
| A-1 | % by weight | 59.35 | 59.35 | 59.35 |
| A-2 | % by weight | 3.65 | 3.65 | 3.65 |
| A-3 | % by weight | 7.00 | 6.80 | 6.60 |
| B-3 | % by weight | 30.00 | 30.00 | 30.00 |
| C | % by weight | | 0.20 | 0.40 |
| Tests: | | | | |
| MVR | cm³/(10 min) | 5.6 | 6.0 | 6.3 |
| IMVR20′ | cm³/(10 min) | 7.1 | 7.7 | 8.6 |
| Delta MVR/IMVR20′ | | 1.5 | 1.7 | 2.3 |
| Vicat VST B50 | ° C. | 148.9 | 147.1 | 145.7 |
| Melt visc. at 280° C. | | | | |
| eta 50 | Pa · s | 1525 | 1450 | 1345 |
| eta 100 | Pa · s | 1279 | 1218 | 1168 |
| eta 200 | Pa · s | 1065 | 1014 | 975 |
| eta 500 | Pa · s | 785 | 746 | 718 |
| eta 1000 | Pa · s | 551 | 535 | 511 |
| eta 1500 | Pa · s | 433 | 419 | 406 |
| eta 5000 | Pa · s | 200 | 185 | 181 |
| Melt visc, at 300° C. | | | | |
| eta 50 | Pa · s | 731 | 714 | 684 |
| eta 100 | Pa · s | 646 | 628 | 613 |
| eta 200 | Pa · s | 552 | 530 | 521 |
| eta 500 | Pa · s | 428 | 410 | 401 |
| eta 1000 | Pa · s | 337 | 323 | 314 |
| eta 1500 | Pa · s | 281 | 268 | 264 |
| eta 5000 | Pa · s | 139 | 136 | 133 |
| Tensile test | | | | 15 |
| Tensile stress at yield | N/mm² | n.d. | n.d. | n.d. |
| Elongation at yield | % | n.d. | n.d. | n.d. |
| Tensile strength | N/mm² | 140.4 | 147.2 | 145.3 |
| Tensile stress at break | N/mm² | 140.4 | 146.8 | 145.3 |
| Elongation at break | % | 1.2 | 1.3 | 1.2 |
| Nominal elongation at | % | 2.2 | 2.3 | 2.3 |
| break | | | | |
| Modulus of elasticity | N/mm² | 17765 | 17699 | 18174 |

1.-15. (canceled)

16. A thermoplastic composition, containing
A) 50.0% by weight to 91.95% by weight of aromatic polycarbonate,
B) 8% to 49.95% by weight of carbon fibers,
C) 0.05% by weight to 10.0% by weight of epoxidized triacylglycerol.

17. The thermoplastic composition as claimed in claim 16, wherein the composition contains
A) 77.0% by weight to 91.5% by weight of aromatic polycarbonate,
B) 8% to 22% by weight of carbon fibers,
C) 0.2% to 1.0% by weight of epoxidized triacylglycerol,
D) 0.005% to 0.5% by weight of heat stabilizer and
E) 0.1% to 3% by weight of further additives.

18. The thermoplastic composition as claimed in claim 17, wherein the composition contains, as further additive, at least one alkali metal, alkaline earth metal and/or ammonium salt of an aliphatic or aromatic sulfonic acid, sulfonamide or sulfonimide derivative.

19. The thermoplastic composition as claimed in claim 16, wherein, as further additive, 0.1% to 0.5% by weight of potassium perfluoro-1-butanesulfonate is present.

20. The thermoplastic composition as claimed in claim 16, wherein the amount of epoxidized triacylglycerol in the composition is ≤0.8% by weight.

21. The thermoplastic composition as claimed in claim 16, wherein, as aromatic polycarbonate, bisphenol A-based polycarbonate is present.

22. The thermoplastic composition as claimed in claim 16, wherein the epoxidized triacylglycerol contains a mixture of triesters of glycerol with oleic acid, linoleic acid, linolenic acid, palmitic acid and/or stearic acid.

23. The thermoplastic composition as claimed in claim 16, wherein, as aromatic polycarbonate, exclusively aromatic homopolycarbonate is present.

24. The thermoplastic composition as claimed in claim 16, wherein at least 90% by weight of the C═C double bonds from the carboxylic acid moieties of the triacylglycerols have been completely epoxidized.

25. The thermoplastic composition as claimed in claim 16, wherein component C is introduced into the thermoplastic composition by admixing epoxidized soybean oil (CAS number 8013-07-8).

26. The thermoplastic composition as claimed in claim 25, wherein the acid number of the epoxidized soybean oil is ≤0.5 mg KOH/g, determined by DIN EN ISO 2114:2006-11.

27. The thermoplastic composition as claimed in claim 17, wherein the additives are selected from the group of the antioxidants, demolding agents, flame retardants, UV absorbers, IR absorbers, impact modifiers, antistats, optical brighteners, fillers other than component B, light-scattering agents, colorants such as organic pigments, inorganic pigments and/or additives for laser marking, and the composition does not contain any further components.

28. The thermoplastic composition as claimed in claim 16, wherein the composition consists of
A) 77.0% by weight to 91.5% by weight of aromatic polycarbonate,
B) 8% to 22% by weight of carbon fibers,
C) 0.2% to 1.0% by weight of epoxidized soybean oil, containing epoxidized triacylglycerols,
D) 0.005% to 0.5% by weight of heat stabilizer and
E) 0.1% to 3% by weight of further additives selected from the group consisting of antioxidants, demolding agents, flame retardants, UV absorbers, IR absorbers, impact modifiers, antistats, optical brighteners, light-scattering agents, colorants, including inorganic pigments, and/or additives for laser marking.

29. A molding consisting of or comprising a thermoplastic composition as claimed in claim 16.

30. A method comprising providing an epoxidized triacylglycerol and improving the flowability of glass fiber- and/or carbon fiber-containing thermoplastic compositions based on aromatic polycarbonate.
